(19) United States
(12) Patent Application Publication
(10) Pub. No.: US 2021/0115295 A1
(43) Pub. Date: Apr. 22, 2021

(54) POLYSILOXANE RESIN COMPOSITION

(71) Applicants: DOW GLOBAL TECHNOLOGIES LLC, Midland, MI (US); DOW SILICONES CORPORATION, Midland, MI (US)

(72) Inventors: Xiaomei SONG, Shanghai (CN); Guodong SHEN, Shanghai (CN); Hongyu CHEN, Shanghai (CN); Linfei WANG, Shanghai (CN); Yunlong GUO, Shanghai (CN)

(73) Assignees: DOW GLOBAL TECHNOLOGIES LLC, Midland, MI (US); DOW SILICONES CORPORATION, Midland, MI (US)

(21) Appl. No.: 16/970,812

(22) PCT Filed: Jan. 31, 2018
(86) PCT No.: PCT/CN2018/074664

§ 371 Date: Aug. 18, 2020

(51) Int. Cl. C09D 183/04; C09D 5/00; C08L 83/04

(52) U.S. Cl. CPC C09D 183/04; C08L 83/04; C09D 5/00

(57) ABSTRACT

A coating composition is disclosed. The coating composition generally provides a coating which is easy to clean, e.g. from an oil stain. The coating composition contains, based on the solid contents of the coating composition; (A) 72 to 90 weight % of a methylpolysiloxane resin; (B) 3 to 8 weight % of a polydimethylsiloxane; (C) 7 to 18 weight % of a silane adhesion promoter with a specific chemical structure; and (D) 0.1 to 0.3 weight % of a catalyst. The coating composition optionally contains (E) a reaction product of a composition containing diisocyanate and polydimethylsiloxane. The coating composition optionally contains (F) a fluorinated silane, in addition or alternate to component (E).

### CROSS-REFERENCE TO RELATED APPLICATIONS

This application is the National Stage of International Appl. No. PCT/CN2018/074664 filed on 31 Jan. 2018, the content of which is hereby incorporated by reference.

### TECHNICAL FIELD

The present invention relates generally to a coating composition which provides a coating with an easy to clean from oil stain. Especially, the coating formed from the coating composition shows good oil repellent and high temperature resistance, as well as good adhesion to an article to be coated and good abrasion resistance.

### INTRODUCTION/BACKGROUND

Silicone coatings are well known as protective and decorative coatings for metals such as steel or aluminum, glasses and woods. One of the protective coatings is an easy-to-clean coating from oil stains. Especially, easy to clean properties from oil stain are strongly required for cooking apparatuses and devices, such as microwave oven, roaster, range hood and pan or skillet. In addition, these equipment need to resist oily grime and need good abrasion resistance. Furthermore, some of these equipment are used at high temperature or high moisture humidity such as microwave ovens.

Some prior art references disclose an easy-to-clean coatings from oil stains, for example, JP3,475,128B, CN105504898A, US2010/0129672A and JP5,513,723B.

### SUMMARY OF INVENTION

The present invention provides a coating composition which provides a coating with very good oil repellent, high temperature resistance, good adhesion and good abrasion resistance.

One aspect of the invention relates to a composition for forming an anti-fouling film on an article, wherein the composition comprises, based on the solid contents of the composition: (A) 72 to 90 weight % of a methylpolysiloxane resin, (B) 3 to 8 weight % of a polydimethylsiloxane represented by the general formula (I): R¹O(Me₂SiO)ₐMe₂SiOR¹, wherein Me is a methyl group, R¹ is an alkyl group having 1 to 4 carbon atoms or a hydrogen atom and a is a natural number, (C) 7 to 18 weight % of a silane adhesion promoter represented by the general formula (II): R²_{b}Si(OR³)_{c}, wherein R² is an alkyl group having 1 to 4 carbon atoms, R³ is an alkyl group having 1 to 4 carbon atoms or a hydrogen atom, b is an integer from 0 to 1 and c is an integer from 3 to 4 and (D) 0.1 to 0.3 weight % of a catalyst. The composition optionally comprises at least one of (E) 2 to 13 weight % of a reaction product of a composition comprising diisocyanate and polydimethylsiloxane and (F) 2 to 13 weight % of a fluorinated silane represented by the general formula (III): (CF₃(CF₂)_{d}(CH₂)ₑ)MeSi(OR⁴)₂, wherein Me is a methyl group, R⁴ is an alkyl group having 1 to 4 carbon atoms or a hydrogen atom, d is an integer from 0 to 10, e is an integer from 1 to 5.

In another aspect, the invention relates to a polysiloxane resin composition comprising, based on the solid contents of the composition: (A) 75 to 95 weight % of a methylpolysiloxane resin, (B) 3 to 8 weight % of a polydimethylsiloxane represented by the general formula (I): R¹O(Me₂SiO)ₐMe₂SiOR¹, wherein Me is a methyl group, R¹ is an alkyl group having 1 to 4 carbon atoms or a hydrogen atom and a is a natural number, (E) 3 to 14 weight % of a reaction product of a composition comprising diisocyanate and polydimethylsiloxane, and (D) 0.1 to 0.3 weight % of a catalyst.

The composition optionally comprises at least one of (C) 5 to 20 weight % of a silane adhesion promoter represented by the general formula (II): R²_{b}Si(OR³)_{c}, wherein R² is an alkyl group having 1 to 4 carbon atoms, R³ is an alkyl group having 1 to 4 carbon atoms or a hydrogen atom, b is an integer from 0 to 1 and c is an integer from 3 to 4, and (F) 3 to 13 weight % of a fluorinated silane represented by the general formula (III): (CF₃(CF₂)_{d}(CH₂)ₑ)MeSi(OR⁴)₂, wherein Me is a methyl group, R⁴ is an alkyl group having 1 to 4 carbon atoms or a hydrogen atom, d is an integer from 0 to 10, e is an integer from 1 to 5.

In yet another aspect, the invention relates to coating films formed from the above mentioned compositions.

### BRIEF DESCRIPTION OF DRAWINGS

FIG. 1 shows a reaction scheme.

FIG. 2 shows mark pen test samples, before rubbed off.

FIG. 3 shows mark pen test samples, after rubbed off.

### DETAILED DESCRIPTION OF EMBODIMENTS

One aspect of the invention is a composition for forming an anti-fouling film on an article, and comprises (A) a methylpolysiloxane resin, (B) a polydimethylsiloxane represented by a specific general formula, (C) a silane adhesion promoter represented by a specific general formula and (D) a catalyst. The composition optionally comprises (E) a reaction product of a composition comprising diisocyanate and polydimethylsiloxane and (F) a fluorinated silane represented by a specific general formula.

(A) Methylpolysiloxane Resin

Methylpolysiloxane resin used in the polysiloxane resin composition is a crosslinked polysiloxane polymer, and works as a matrix polymer in the coating composition. The methylpolysiloxane resin is also called as ‘binder resin’ or ‘matrix resin’. Preferably, the methylpolysiloxane resin has an average unit formula of Me_{f}SiO_{(4-f-g-h)/2}(OH)_{g}(OR⁵)ₕ, wherein Me is a methyl group, R⁵ is an alkyl group having 1 to 4 carbon atoms, f is a positive number of 1 or larger and 2 or less, g is a positive number from which the amount of a hydroxyl group combined with a silicon atom in the compound will be 1 to 5.5 by weight, h is a positive number from which the amount of OR⁵ group combined with a silicon atom in the compound will be 0.1 to 4% by weight, and the sum of the amount of the hydroxyl group and OR⁵ group is 2.1 to 5.1% by weight. The viscosity of the methylpolysiloxane resin is preferably higher than 10,000 centistokes, more preferably higher than 20,000 centistokes.

The methylpolysiloxane resin is typically formed by crosslinking of a trifunctional siloxane with other trifunctional siloxanes or difunctional siloxanes. In some embodiments, the methylpolysiloxane resin can be formed by the crosslinking of a monomer mixture, wherein the monomer mixture is polyvinyl terminated polydimethylsiloxane, a polymethylvinyl terminated polydimethylsiloxane, a methylhydrogen siloxane and tetramethyl tetravinyl cyclotetrasiloxane. In other embodiments, the methylpolysiloxane resin can be formed by further crosslinking with oligomers that formed by such monomer mixture. More specifically, suitable examples of the methylpolysiloxane resin are methyl silyl and silanol terminated poly silsesquioxane; trimethyl silyl and dimethyl vinyl silyl terminated poly silsesquioxane; organopolysiloxane represented by the following formula: [MeSiO_{3/2}]ᵢ[Me₂SiO]ⱼ[RO_{1/2}]ₖ, i+j=1, k<2; organopolysiloxane represented by the following formula: [SiO₂]ₒ[Me₃SiO_{1/2}]ₚ[Me₂VinylSiO_{1/2}]_{q}[HO_{1/2}]ᵣ, o+p+q=1, o: (p+q)=0.7˜1, b:q=1˜4, r<0.05 and a mixture of the said two resins with poly dimethyl siloxane or poly vinylmethyl siloxane. The methylpolysiloxane resin is typically formulated as either 1-component or 2-component silicone composition. The methylpolysiloxane resin may be cross-linked during the curing process.

The amount of methylpolysiloxane resin in the polysiloxane resin composition is from 72 to 90 weight %, preferably from 75 to 80 weight % based on the weight of the solid contents of the polysiloxane resin composition.

(B) Polydimethylsiloxane Represented by a Specific General Formula

A polydimethylsiloxane used in the present invention is represented by the following general formula (I):

R¹O(Me₂SiO)ₐMe₂SiOR¹ (I)

In the formula, Me is a methyl group. R¹ is an alkyl group having 1 to 4 carbon atoms, or a hydrogen atom. Examples of R¹ includes a hydrogen atom, a methyl group, an ethyl group, a n-propyl group, a sec-propyl group, n-butyl group and a tert-butyl group. Preferably, R¹ is a hydrogen atom or a methyl group. At least one of R¹ is a hydrogen atom. Preferably, at least one of each end of the formula, totally at least two of R¹, are hydrogen atoms. a is a natural number from 100 to 300, preferably from 200 to 300.

Preferably, the viscosity of the polydimethylsiloxane is from 10,000 to 100,000 centistokes. More preferably, the viscosity of the polydimethylsiloxane is from 15,000 to 50,000 centistokes.

The amount of polydimethylsiloxane in the polysiloxane resin composition is from 3 to 8 weight %, preferably from 4 to 6 weight % based on the weight of the solid contents of the polysiloxane resin composition.

Since at least one of R₁ is a hydrogen atom, the polydimethylsiloxane can react with the methylpolysiloxane resin during curing step and form a crosslink network in a coating. In addition, since the polydimethylsiloxane has a straight and quite long chain, it works as a lubricant because of its chain flexibility, thus it contributes good easy-to-clean property of the coating.

The weight ratio of methylpolysiloxane resin (matrix resin) over polydimethylsiloxane is from 9 to 18, preferably from 10 to 15.

(C) A Silane Adhesion Promoter

The polysiloxane resin composition of the present invention can further comprise a silane adhesion promoter represented by the general formula (II):

R²_{b}Si(OR³)_{c} (II)

In the formula, R² is an alkyl group having 1 to 4 carbon atoms. R³ is an alkyl group having 1 to 4 of carbon atoms, or a hydrogen atom. Examples of R² and R³ include a methyl group, an ethyl group, a n-propyl group, a sec-propyl group, n-butyl group and a tert-butyl group. Preferably, R² is a methyl group. b is an integer from 0 to 1. c is an integer from 3 to 4.

When the polysiloxane resin composition comprises a silane adhesion promoter, the amount of the adhesion promoter in the polysiloxane resin composition is from 7 to 18 weight %, preferably from 10 to 15 weight % based on the weight of the solid contents of the polysiloxane resin composition.

(D) Catalyst

Catalyst used in the polysiloxane resin composition of the invention is a catalyst for crosslinking of silicone matrix resin. Any known catalyst can be used. Examples of such catalyst include, but are not limited to, zirconium compound such as zirconium octoate and zirconium acetate, titanium compound such as titanium (IV) butoxide and zinc compound such as zinc octoate and zinc acetate.

The amount of catalyst in the coating composition should be sufficient to crosslink silicone matrix resin, but typically is from 500 to 4,000 ppm, preferably from 1,000 to 3,000 ppm as a metal, based on the weight of the solid contents of the coating composition.

(E) A Reaction Product of a Composition Comprising Diisocyanate and Polydimethylsiloxane

The polysiloxane resin composition of the present invention can further comprise a reaction product of a composition comprising diisocyanate and polydimethylsiloxane, which is useful to further enhance oily grime resistance. Diisocyanate has two cyanate groups (—N═C═O) and can react with a reaction group of polydimethylsiloxane. Examples of diisocyanate include hexamethylene diisocyanate (HDI), isophorone diisocyanate (IPDI), dicyclohexylmethane 4,4′-diisocyanate (HMDI), toluene 2,4-diisocyanate (TDI) and 4,4′-diphenyl methane diisocyanate (MDI).

Polydimethylsiloxane included in the composition has at least two reactive groups in the molecule. Preferably, the polydimethylsiloxane has at least two amine groups. The most preferably, the polydimethylsiloxane has two amine groups at the each ends of the molecule. The polydimethylsiloxane which has two amine groups can be synthesized from aminosilane and dihydroxy-polydimethylsiloxane.

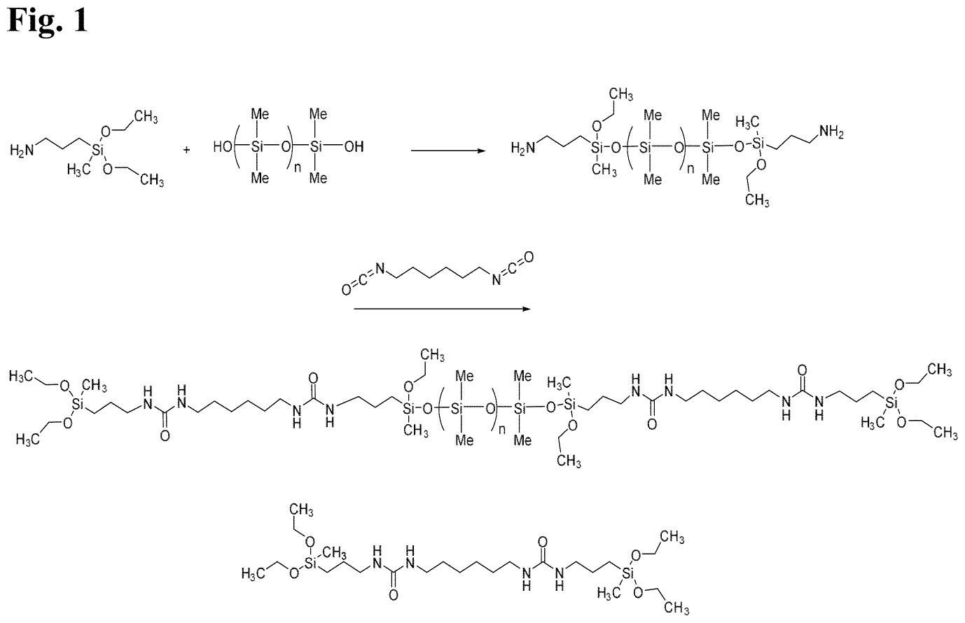

For example, the reaction product used in the present invention can be synthesized by the reaction formula/scheme illustrated in FIG. 1.

The mole ratio of diisocyanate and polydimethylsiloxane is preferably from 2:1 to 14:1, more preferably from 2:1 to 10:1.

The molecular weight of the reaction product is preferably from 1,000 to 8000, more preferably from 1,000 to 5,000 calculated by Gel permeation chromatography method (GPC). The viscosity of the reaction product is preferably from 1,000 to 20,000 centistokes, more preferably from 1,000 to 10,000 centistokes. The reactant is diluted with ethanol/2-propanol at a mole ratio at 2.7 to a solid content at about 25% before formulated to the polysiloxane composition.

The amount of the reaction product in the polysiloxane resin composition is from 2 to 13 weight %, preferably from 3 to 10 weight % based on the weight of the solid contents of the polysiloxane resin composition. The reaction product works as easy to clean enhancement additive with hydrophilic nature yielding from urea bonds in the polysiloxane resin composition, it showed very good compatibility with the polysiloxane resin composition.

(F) A Fluorinated Silane Represented by a Specific General Formula

The composition can further comprise fluorinated silane. The fluorinated silane is represented by the general formula (III):

(CF₃(CF₂)_{d}(CH₂)ₑ)MeSi(OR⁴)₂ (III)

In the formula, Me is a methyl group, R⁴ is an alkyl group having 1 to 4 carbon atoms or a hydrogen atom. d is an integer from 0 to 10, and e is an integer from 1 to 5.

The amount of the fluorinated silane in the composition is from 2 to 13 weight %, preferably from 3 to 10 weight % based on the weight of the solid contents of the composition.

Other Ingredients

The polysiloxane resin composition of the invention can include other ingredients such as solvent, filler, surfactant, silicone fluid, wetting agent and dye, these are known to those skilled in the art. When the polysiloxane resin composition comprises a solvent, any solvent such as alcohols, esters, ethers, ketones, ether-alcohols, aromatic hydrocarbons, aliphatic hydrocarbons, halogenated hydrocarbons and volatile silicones can be used. The amount of solvent in the polysiloxane resin composition can be from 60 to 85 weight %, preferably from 70 to 80 weight % based on the weight of the total solution.

Another aspect of the invention is a polysiloxane resin composition comprising (A) 75 to 95 weight % of a methylpolysiloxane resin, (B) 3 to 8 weight % of a polydimethylsiloxane represented by the general formula (I): R¹O(Me₂SiO)ₐMe₂SiOR¹, wherein Me is a methyl group, R¹ is an alkyl group having 1 to 4 carbon atoms or a hydrogen atom and a is a natural number, (D) 0.1 to 0.3 weight % of a catalyst and (E) 3 to 14 weight % of a reaction product of a composition comprising diisocyanate and polydimethylsiloxane. The polysiloxane resin composition can further comprise at least one of (C) 5 to 20 weight % of a silane adhesion promoter and (F) 3 to 13 weight % of a fluorinated silane represented by a specific general formula. All the components are same as disclosed above. The composition is especially useful for coatings of roaster and range hood, because the composition provides a coating film which shows excellent oil grime resistance and abrasion resistance.

Article and Film

The polysiloxane resin composition or a composition for forming an anti-fouling film can be applied on an article and form a film at least a part of the surface of the article. When applying the composition on an article, variety of techniques can be used such as splaying, brushing roller, dip coating, spin coating, wire coating and the like. Then, typically the article is heated to cure the composition on the surface of the article. Conditions such as temperature or heating time are vary and are known to those skilled in the art. Thickness of the film is preferably from 5 to 20 micrometers, more preferably from 5 to 15 micrometers. Examples of such article include, but are not limited to, microwave oven, roaster, range hood and pan or skillet.

The film formed from the composition shows very good oil repellent, high temperature resistance, good adhesion and abrasion resistance.

### EXAMPLES

Preparation of Reaction Products

The raw materials disclosed in Table 1 were used for the preparation of reaction products.

TABLE 1
Raw materials

| Chemical name | Description | Supplier |
|---|---|---|
| Hexamethylene diisocyanate | Reactive component | Sigma-Aldrich |
| 3-aminopropylmethyldiethoxysilane | Reactive component | Dow Corning |
| Polydimethylsiloxane | hydroxyl content is | Dow Corning |
| | 2 wt. %, Mw = 2,600 | |
| Ethanol | Solvent | Sigma-Aldrich |
| 2-propanol | Solvent | Sigma-Aldrich |

Reaction product (RP-1):

Weighed 3.8 g of Amino silane and mixed with 26.0 of Dihydroxy polymethylsiloxane at room temperature and homogeneously stirring for 24 hours. Then weighed 11.9 g of ethanol and 4.5 g of 2-propanol (ethanol/2-propanol at a mole ratio at 2.7) and added to the above mixture to dilute the above reactants. Finally weighed 6.7g of Hexamethylene diisocyanate and added into the above solution. After completely dipped, homogeneously mixed for another half an hour.

The raw materials disclosed in Table 2 were used to prepare samples in Examples.

TABLE 2
Raw materials description

| Material | | |
|---|---|---|
| Type | Description | Supplier |
| A-1 | Methyl polysiloxane resin with average Mw | Wacker Chemie AG |
| | around 6000~7000, in 50% toluene | |
| A-2 | Silicone oligomer comprising alkoxysiloxane, | ShinEtsu Company |
| | alkoxysilane, and alkoxide | |
| B-1 | Silanol terminated polydimethylsiloxane with | Dow Corning |
| | Mw around 15,000 to 20,000 | |
| C-1 | Gamma-chloropropyltrichlorosilane | Dow Corning |
| C-2 | 3-glycidoxypropyltrimethoxysilane | Dow Corning |
| C-3 | Methyltriethoxysilane | Dow Corning |
| C-4 | Tetraethoxysilane, industrial grade | Dow Corning |
| F-1 | Dimethoxy-methyl(3,3,3- | Sigma-Aldrich |
| | trifluoropropyl)silane, Silane with 3 fluorine | |
| | atoms in the molecule | |
| F-2 | 1H,1H,2H,2H-Perfluorodecyltriethoxysilane, | Sigma-Aldrich |
| | Silane with 17 fluorine atoms in the molecule | |
| D-1 | Catalyst comprising Zirconium compound | Sigma-Aldrich |
| | with 6% concentration (as metal) for | |
| | condensation reaction | |
| D-2 | Catalyst comprising Tin compound for | Dow Corning |
| | condensation reaction (Tin content is | |
| | 22.5-24.5%, diluted with toluene to | |
| | 10% when preparing samples) | |
| Silicone | Co-solvent for high molecular weight | Dow Corning |
| fluid | polydimethylsiloxane | |
| Iso- | Solvent | Exxon Mobil |
| paraffin | | Corporation |

Weighed the raw materials according to specific formulations in Tables 3-4, homogeneously mixed by shaking for 30 minutes. 0.6 m1 solution was blade coated on stainless steel panel and cured at 200° C. for 1 hour or 30minutes according to different formulations. Dry film thickness was detected after fully cured and their pencil hardness were evaluated and listed in Tables 3-4. The results of adhesion after boiling water test and mark pen testing ranking results were listed in Table 3. Abrasion resistance and oil easy to clean performance ranking were listed in Tables 4.

<Analytical Method>

(1) Basic coating properties test

Pencil hardness test according to ASTM D3363.

(2) Adhesion test:

Cross hatch tape test according to ASTM D3359-02.

(3) High temperature resistance test

Put the coated panels into oven and increase the temperature to 280° C. and keep for 1 hour, then observe surface appearance and color of the coatings.

(4) Easy to clean ranking (Mark pen test)

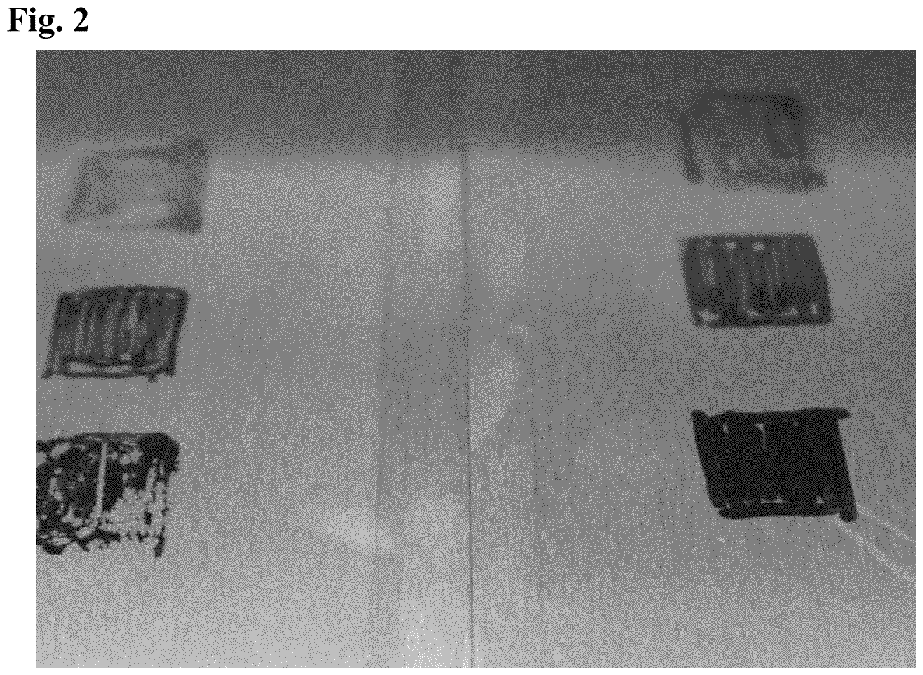

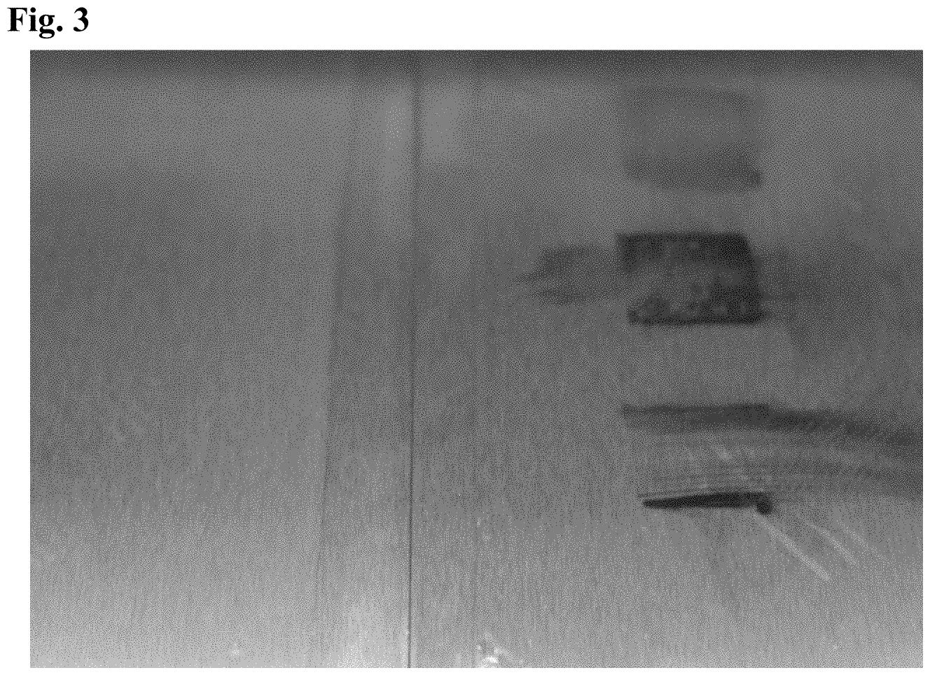

Mark pen test can be used to evaluate the liquid oil easy to clean and anti-graffiti performance. Paint the coatings with mark pens and leave for 1 minute to fully evaporate the solvent, then rub off with a tissue paper or dry cotton towel. FIG. 2 shows two samples—left one and right one—for mark pen test before rubbed off. FIG. 3 shows samples for mark pen test after rubbed off. The easy to clean performance can be ranked as A: fully cleaned (the left sample) or B: not fully cleaned (the right sample). The beading effect of those marks can also be an indicator of the easy to clean performance. Mark pen test results of easy to clean coating formulations in Table 3 were recorded.

(5) Field test in kitchen

(5-1) Test for easy to clean performance of oily grime

Placed the plate coated with easy clean coatings shown in Table 4 under range hood sash in kitchen and kept for 3 months for oily grime to accumulate on the surface. Then put the plates in oven to further cure for 2 hours at 200° C. and cleaned with tissue papers, record as can be easily cleaned, can be cleaned or not.

(5-2) Oil film was observed after cleaning with papers and recorded in Table 4. Oil film is an indicator for oil resistance ability of these coatings.

(6) Coating durability test method (Boiling water resistance test)

Put the coated panels into water tank with boiling water, 8 hours as 1 cycle, after each cycle, took out the panels and laid for 16 hours at room temperature and recorded coating appearance, then continued another cycle until coating failure or totally accumulated to 500 hours, stopped the test. Observed coating appearance and tested coating adhesion according to Cross hatch tape test ASTM D3359-02.

(7) Abrasion resistance test

The coating surface was scratched for 10,000 times with a microfiber tissue (provided by 3M Company) with 10N force using Taber abrasion tester. After that, observed coating appearance and evaluated mark pen test performance again and compared with as-prepared coatings. Ranking as: 5-excellent, no scratch, mark pen ranking as A; 4-very good, only a little scratch, mark pen ranking as A; 3- good, a little scratch, mark pen ranking as A; 2-moderate, scratched, mark pen ranking as B; 1-coating failed.

TABLE 3
Easy to clean coating formulations and results

| | Control | Control | Control | Control |
|---|---|---|---|---|
| | Ex.1 | Ex.2 | Ex.3 | Ex.4 |
| A-1/g | 3.6 | 3.6 | 3.6 | 3.6 |
| B-1/g | — | 0.2 | 0.2 | 0.2 |
| C-1/g | — | — | 0.2 | — |
| C-2/g | — | — | — | 0.2 |
| C-3/g | — | — | — | — |
| C-4/g | — | — | — | — |
| D-1/g | 0.08 | 0.08 | 0.08 | 0.08 |
| Silicone fluid/g | 1.0 | 1.0 | 1.0 | 1.0 |
| Isoparaffin/g | 5.2 | 5.2 | 5.2 | 5.2 |
| Curing | 200 | 200 | 200 | 200 |
| temperature/° C. | | | | |
| Curing | 1.0 | 1.0 | 1.0 | 1.0 |
| time/h | | | | |
| film thickness | 15 | 15 | 15 | 15 |
| (dry)/μm | | | | |
| Hardness | 3H | 2H | 2H | 2H |
| Boiling water | 24 | 34 | 24 | 24 |
| resistance/h | | | | |
| Easy to clean | B | A | A | A |
| ranking | | | | |
| (Mark pen test) | | | | |
| High temperature | no | no | no | no |
| resist (280° C., 1 h) | change | change | change | change |
| | Inventive | Inventive | Inventive | Inventive |
| | Ex. 1 | Ex. 2 | Ex. 3 | Ex. 4 |
| A-1/g | 3.6 | 3.6 | 3.6 | 3.6 |
| B-1/g | 0.2 | 0.2 | 0.2 | 0.2 |
| C-1/g | — | — | — | — |
| C-2/g | — | — | — | — |
| C-3/g | 0.2 | 0.5 | — | — |
| C-4/g | — | — | 0.2 | 0.5 |
| D-1/g | 0.08 | 0.08 | 0.08 | 0.08 |
| Silicone fluid/g | 1.0 | 1.0 | 1.0 | 1.0 |
| Isoparaffin/g | 5.2 | 5.2 | 5.2 | 5.2 |
| Curing | 200 | 200 | 200 | 200 |
| temperature/° C. | | | | |
| Curing | 1.0 | 1.0 | 1.0 | 1.0 |
| time/h | | | | |
| film thickness | 15 | 15 | 15 | 15 |
| (dry)/μm | | | | |
| Hardness | 3H | 3H | 3H | 3H |
| Boiling water | 152 | 192 | 240 | >500 |
| resistance/h | | | | |
| Easy to clean | A | A | A | A |
| ranking | | | | |
| (Mark pen test) | | | | |
| High temperature | no | no | no | no |
| resist (280° C., 1 h) | change | change | change | change |

TABLE 4
Easy to clean coating formulations and results

| | Control | Control | Inventive | Inventive | Inventive | Inventive | Inventive |
|---|---|---|---|---|---|---|---|
| | Ex. 5 | Ex. 6 | Ex. 5 | Ex. 6 | Ex. 7 | Ex. 8 | Ex. 9 |
| A-1/g | 3.6 | 3.6 | 3.6 | 3.6 | 3.6 | 3.6 | 3.6 |
| A-2/g | — | — | — | — | — | — | 0.9 |
| B-1/g | 0.2 | 0.2 | 0.1 | 0.1 | 0.2 | 0.1 | 0.1 |
| C-4/g | — | 0.2 | 0.5 | 0.5 | 0.5 | 0.5 | 0.5 |
| F-1/g | — | — | — | 0.1 | 0.1 | — | 0.1 |
| F-2/g | — | — | — | — | — | 0.1 | — |
| RP-1/g | — | — | — | — | — | — | — |
| D-1/g | 0.08 | 0.08 | 0.08 | 0.08 | 0.08 | 0.08 | 0.08 |
| D-2/g | — | — | — | — | — | — | — |
| Silicone fluid/g | 1.0 | 1.0 | 1.0 | 1.0 | 1.0 | 1.0 | 1.0 |
| Isoparaffin/g | 5.2 | 5.2 | 5.2 | 5.2 | 5.2 | 5.2 | 5.2 |
| Curing temperature/° C. | 200 | 200 | 200 | 200 | 200 | 200 | 200 |
| Curing time/min | 30 | 30 | 30 | 30 | 30 | 30 | 30 |
| film thickness (dry)/μm | 15 | 15 | 15 | 15 | 15 | 15 | 15 |
| Hardness | 2H | 2H | 3H | 3H | 3H | 3H | 3H |
| Abrasion-resistance | 2 | 2 | 3 | 4 | 4 | 4 | 5 |
| ranking 1-5 | | | | | | | |
| Field test at kitchen | No | No | Easy | Very | Very | Very | Very |
| for 3 months, oily grime | | | | easy | easy | easy | easy |
| can be cleaned or not | | | | | | | |
| Oil film after cleaning | Yes | Yes | Yes | Yes | Yes | Yes | Yes |

| | Inventive | Inventive | Inventive | Inventive | Inventive | Inventive |
|---|---|---|---|---|---|---|
| | Ex. 10 | Ex. 11 | Ex. 12 | Ex. 13 | Ex. 14 | Ex. 15 |
| A-1/g | 3.6 | 3.6 | 3.6 | 3.6 | 3.6 | 3.6 |
| A-2/g | 0.45 | — | — | — | 0.9 | 0.45 |
| B-1/g | 0.2 | 0.1 | 0.1 | 0.1 | 0.1 | 0.1 |
| C-4/g | 0.5 | 0.2 | 0.2 | 0.2 | 0.2 | 0.2 |
| F-1/g | 0.1 | — | 0.1 | — | 0.1 | 0.1 |
| F-2/g | — | — | — | 0.1 | — | — |
| RP-1/g | — | 1.1 | 1.1 | 1.1 | 1.1 | 1.1 |
| D-1/g | 0.08 | 0.04 | 0.04 | 0.04 | 0.04 | 0.04 |
| D-2/g | — | 0.02 | 0.02 | 0.02 | 0.02 | 0.02 |
| Silicone fluid/g | 1.0 | 1.0 | 1.0 | 1.0 | 1.0 | 1.0 |
| Isoparaffin/g | 5.2 | 5.2 | 5.2 | 5.2 | 5.2 | 5.2 |
| Curing | 200 | 200 | 200 | 200 | 200 | 200 |
| temperature/° C. | | | | | | |
| Curing | 30 | 30 | 30 | 30 | 30 | 30 |
| time/min | | | | | | |
| film thickness | 15 | 15 | 15 | 15 | 15 | 15 |
| (dry)/μm | | | | | | |
| Hardness | 3H | 3H | 3H | 3H | 3H | 3H |
| Abrasion-resistance | 5 | 3 | 4 | 3 | 5 | 4 |
| ranking 1-5 | | | | | | |
| Field test at kitchen | Very | Very | Very | Very | Very | Very |
| for 3 months, oily grime | easy | easy | easy | easy | easy | easy |
| can be cleaned or not | | | | | | |
| Oil film after cleaning | No | No | No | No | No | No |

1. A composition for forming an anti-fouling film on an article, wherein the composition comprises, based on the solid contents of the composition:
(A) 72 to 90 weight % of a methylpolysiloxane resin;
(B) 3 to 8 weight % of a polydimethylsiloxane represented by the general formula (I):
R¹O(Me₂SiO)ₐMe₂SiOR¹ (I)
wherein Me is a methyl group, R¹ is an alkyl group having 1 to 4 carbon atoms or a hydrogen atom, and a is a natural number;
(C) 7 to 18 weight % of a silane adhesion promoter represented by the general formula (II):
R²_{b}Si(OR³)_{c} (II)
wherein R² is an alkyl group having 1 to 4 carbon atoms, R³ is an alkyl group having 1 to 4 carbon atoms or a hydrogen atom, b is an integer from 0 to 1, and c is an integer from 3 to 4; and
(D) 0.1 to 0.3 weight % of a catalyst.

2. The composition of claim 1, further comprising
(E) 2 to 13 weight % of a reaction product of a composition comprising a diisocyanate and a polydimethylsiloxane.

3. The composition of claim 1, further comprising
(F) 2 to 13 weight % of a fluorinated silane represented by the general formula (III):
(CF₃(CF₂)_{d}(CH₂)ₑ)MeSi(OR⁴)₂ (III)
wherein Me is a methyl group, R⁴ is an alkyl group having 1 to 4 carbon atoms or a hydrogen atom, d is an integer from 0 to 10, and e is an integer from 1 to 5.

4. The composition of claim 2, wherein the polydimethylsiloxane used to form component (E) has at least two amino groups.

5. The composition of claim 2, wherein the reaction ratio of the diisocyanate with the polydimethylsiloxane is from 2:1 to 14:1 by molar ratio.

6. The composition of claim 2, wherein the molecular weight of the reaction product is from 1,000 to 8,000.

7. An anti-fouling film on an article, wherein the anti-fouling film is formed from the composition of claim 1.

8. A polysiloxane resin composition comprising, based on the solid contents of the composition:
(A) 75 to 95 weight % of a methylpolysiloxane resin;
(B) 3 to 8 weight % of a polydimethylsiloxane represented by the general formula (I):
R¹O(Me₂SiO)ₐMe₂SiOR¹ (I)
wherein Me is a methyl group, R¹ is an alkyl group having 1 to 4 carbon atoms or a hydrogen atom, and a is a natural number;
(E) 3 to 14 weight % of a reaction product of a composition comprising a diisocyanate and a polydimethylsiloxane; and
(D) 0.1 to 0.3 weight % of a catalyst.

9. The polysiloxane composition of claim 8, further comprising
(C) 5 to 20 weight % of a silane adhesion promoter represented by the general formula (II):
R²_{b}Si(OR³)_{c} (II)
wherein R² is an alkyl group having 1 to 4 carbon atoms, R³ is an alkyl group having 1 to 4 carbon atoms or a hydrogen atom, b is an integer from 0 to 1, and c is an integer from 3 to 4.

10. The polysiloxane composition of claim 8, further comprising
(F) 3 to 13 weight % of a fluorinated silane represented by the general formula (III):
(CF₃(CF₂)_{d}(CH₂)ₑ)MeSi(OR⁴)₂ (III)
wherein Me is a methyl group, R⁴ is an alkyl group having 1 to 4 carbon atoms or a hydrogen atom, d is an integer from 0 to 10, and e is an integer from 1 to 5.

11. A film formed from the polysiloxane composition of claim 8.

12. The composition of claim 2, further comprising
(F) 2 to 13 weight % of a fluorinated silane represented by the general formula (III):
(CF₃(CF₂)_{d}(CH₂)ₑ)MeSi(OR⁴)₂ (III)
wherein Me is a methyl group, R⁴ is an alkyl group having 1 to 4 carbon atoms or a hydrogen atom, d is an integer from 0 to 10, and e is an integer from 1 to 5.

13. The polysiloxane composition of claim 9, further comprising
(F) 3 to 13 weight % of a fluorinated silane represented by the general formula (III):
(CF₃(CF₂)_{d}(CH₂)ₑ)MeSi(OR⁴)₂ (III)
wherein Me is a methyl group, R⁴ is an alkyl group having 1 to 4 carbon atoms or a hydrogen atom, d is an integer from 0 to 10, and e is an integer from 1 to 5.
